(19) United States
(12) Patent Application Publication
(10) Pub. No.: US 2006/0235780 A1
(43) Pub. Date: Oct. 19, 2006

(54) Methodology of utilizing Fibonacci numbers to analyze and predict trends in financial markets

(76) Inventor: Scott M. Carney, Tucson, AZ (US)

Correspondence Address: John D. Long;Law Office of John D. Long, 2941 Sage Ridge Drive, Reno, NV, 89509, US

(21) Appl. No.: 11/110,581

(22) Filed: Apr. 19, 2005

(51) Int. Cl. G06Q 40/00

(52) U.S. Cl. 705/35

(57) ABSTRACT

One embodiment of the invention can be a methodology for analyzing financial markets using harmonic patterns which use Fibonacci derived formulae to verify historical market values for selected peak(s) and trough(s) of cyclical financial market to predict the future market value of a new trough or peak that will terminate a current market trend (e.g. a market up swing) and be the beginning point of an new mark trend having a different activity (e.g. a market downswing).

### CROSS-REFERENCES TO RELATED APPLICATIONS

This application incorporates by reference and claims the Apr. 19, 2004 priority date of the U.S. Provisional Patent Application Ser. No. 60/563,743.

### STATEMENT REGARDING FEDERALLY SPONSORED RESEARCH OR DEVELOPMENT

Not Applicable

### REFERENCE TO A “MICROFICHE APPENDIX”

Not Applicable.

### FIELD OF THE INVENTION

The present invention relates to the field of statistical analysis using Fibonacci numbers, and in particular to using Fibonacci numbers for use of the prediction of trends in financial and commodities markets

### BACKGROUND

Fibonacci numbers have long been used as the basis for describing the relationship of both man made and natural phenomena. The use of these numbers is a branch of mathematics accredited to Leonardo De Fibonacci de Pisa (b.1170-d.1240) whose work “Liber Abaci” (“Book of Abacus”) set forth his theories of the Fibonacci number sequence. In this work, Fibonacci originally devised a review of numbers as a solution to a rabbit population prediction. Fibonacci devised a calculation or mathematical formula to predict this population growth (provided that the rabbits would live theoretically indefinitely) as a sequence of numbers (or pairs of rabbits at the end of a specific month) as follows:

0, 1, 2, 3, 5, 8, 13, 21, 34, 55, 89, 144, 233, 377 on through infinity.

After the eighth sequence of the above calibrations, Fibonacci discovered a second mathematical relationship, unrelated to his first calculation, to derive the numbers coming after the eighth sequence in the above sequence. Fibonacci discovered that taking a proceeding number in the sequence and dividing it by its succeeding number yielded a constant 0.168. This number (and others) became known as “Fibonacci” ratios or constants.

In applying this discovery to other numbers in the rabbit population numerical sequence a second Fibonacci ratio or constant was discovered, 1.618.

So, for the rabbit population numerical sequence of 0.34,55, 89,144, 233 . . . these Fibonacci ratios can be seen as follows:
34 divided by 55=0.618181, which rounds off to 0.618
89 divided by 55=1.618181, which rounds off to 1.618
144 divided by 89=1.617977 which rounds off to 1.618
233 divided by 144.=. 1.618055 which rounds off to 1.618

In further analysis, additional Fibonacci constants were also discovered. It was found that these additional Fibonacci constants, the square roots of Fibonacci ratios or constants 0.618 and 1.618, were 0.786 and 1.27 respectively.

The Fibonacci constants can be seen occurring in various mathematical formulae used to describe many natural and man-made phenomena.

For example the Fibonacci ratios or constants 0.618 and 1.618 are found in the physical dimensions of the great Pyramids of Egypt. In comparing the height of each of the pyramids to ½ the lengths of its base both are derived of these Fibonacci numbers.

Fibonacci constants are used in formulae and methodologies that are used to create dimples on golf balls (phyllotaxis systems), encryption formula, formula and means for controlling various electronic systems. They have also been used to predict the occurrence of the high likelihood of failure in industrial systems so that repairs can be effected before the failure occurs.

Fibonacci constants or ratios have also been used to predict nearby future movements or changes in financial markets. Using various software, Fibonacci constants are utilized in conjunction with the tracking of actual trends (movements or curves in marketplace activity in a particular financial market and comparing them against a prediction curve generated by software that utilizes Fibonacci software and historical data of the marketplace trends. Utilizing the prediction curve, the user could make an educated short turn prediction of the market's volatility (i.e., downward trend, upward trend, or no change). This is particularly useful in a financial market where a participant is engaged in short term trading. However the use of specific bands or envelopes for a particular historical curve performance curve of financial market history on which to extrapolate short term future performance projection of a particular financial market my be difficult to institute, analyze and act upon.

What is needed is a simpler, easier to use Fibonacci-based analysis and methodology that can avoid band, envelopes or curves generation and the necessity for multiple calculations for the same. This methodology should be able to readily be applied to financial market activities; to substantially identify patterns in financial market activities, and to readily be understood by the operator to allow the operator to participate in the financial market at generally the best entrances (buying) and exits (selling) of a particular segment for a chosen financial market.

### SUMMARY OF ONE EMBODIMENT OF THE INVENTION

Advantages of One or More Embodiments of the Present Invention

The various embodiments of the present invention may, but do not necessarily, achieve one or more of the following advantages:

provide a methodology which can be used to substantially predict short term price change trends in a financial market;

provide multiple means of confirmation that are possible in an upcoming predictable Fibonacci event (e.g., point reversal zone);

provide multiple means of confirmation to select a correct Fibonacci based analysis to be applied to selected portions of a financial market;

the ability to generally reduce the risk of a misapplication of Fibonacci analysis to the market;

the ability to use Fibonacci numbers in distinct repeatable patterns to predict, with substantial reliability, future short term trends in financial market; and

provide Fibonacci-based patterns that are relatively easy to apply to historical financial market cost data for analyzing future trends in that market.

These and other advantages may be realized by referring to the remaining portions of the specification, claims, and abstract.

Brief Description of One Embodiment of the Present Invention

One possible embodiment of the invention could be A methodology of utilizing Fibonacci numbers to analyze financial market patterns, identifying in historical financial market data, the actual market values of four historical points of distinction X, A, B and C; selecting an appropriate harmonic pattern, selecting the Fibonacci values for the market price differential multipliers for retracement(s) and projection(s) based on harmonic pattern; calculating market place values of points of distinction B and C using X-A retracement and using A-B retracement; comparing the calculated market values of points of distinction B and C to the actual market values of points of distinction B and C derived for the data; calculating the predicted market values of point of distinction D using the B-C projection; and deciding to use predicted market values of point of distinction D to determine the occurrence of a potential reversal zone in the current market trend of the financial market being analyzed.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially a diagram of one embodiment of a retracement of the present invention applied to a historical financial market data.

FIG. 2 is substantially a diagram of one embodiment of the bearish AB=CD pattern of the present invention applied to a historical financial market data.

FIG. 3 is substantially a diagram of one embodiment of the Bat harmonic pattern of the present invention applied to a historical financial market data.

FIG. 4 is substantially a diagram of one embodiment of the Gartley harmonic pattern of the present invention applied to a historical financial market data.

FIG. 5 is substantially a diagram of one embodiment of the Crab harmonic pattern of the present invention applied to a historical financial market data.

FIG. 6 is substantially a diagram of one embodiment of the Ideal Butterfly harmonic pattern of the present invention applied to a historical financial market data.

FIG. 7 is substantially a diagram of one embodiment of the 5-0 harmonic pattern of the present invention applied to a historical financial market data.

FIG. 8 is substantially a flowchart of one embodiment of the methodology of the present invention.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

The invention in at least one embodiment is a methodology 100 called Harmonic Trading. Harmonic Trading utilizes recognizable repeating patterns called harmonic patterns to identify a future point when the market performance will probably reverse its current or trend or course (i.e., go from a downward or bearish price performance trend to an upward or bullish price performance trend and visa versa). By identifying the point in time by the occurrence of specific price or narrow price range for the instrumentality (e.g., the price of a particular company's stock) the methodology tries to identify that point in time as to when there will be a change in market performance trend, the methodology attempts to identify, for the operator, a potentially profitable window for the operator to move into (or out of) a particular financial market (e.g., profitably buy at a lower price and/or sell at a higher price the instrumentalities being traded in the chosen financial market).

This methodology substantially assumes, although the correctness or incorrectness of this assumption does not in any way interfere with the viability of the invention, that artificial or man-made systems, such as financial markets which otherwise appear to follow a chaotic pathway within a generalized wave-based or cyclic format (e.g., have discernable high and low points-peaks and valleys/troughs) have within that format detectable repeating patterns, relationships, or cycles similar to the repeating patterns, relationships, and cycles which may appear in natural systems which also may generally appear randomly in cyclic format. The methodology substantially helps identify these repeating or harmonic patterns, and allow the operator to enter or to exit position(s) in financial market based upon a high degree of probability that the same harmonic pattern will repeat as it has done in the past. The harmonic patterns are identified by formulas using Fibonacci based, derived and related ratios or numbers which have also been useful for identifying repeating patterns, relationships, and cycles in nature. The Fibonacci-based, derived and related ratios formulas also use certain price costs at certain points in the history of the chosen financial market to generally define the extent of price action (e.g., financial market performance) as it is substantially controlled by trading behavior.

Trading behavior may be defined by the extent of the market participants' fear or greed influencing the buying and selling actions in the market. Generally, price action may be seen as moving in cycles that exhibit stages of growth (e.g., upswing) and decline (e.g., downswing). From this perspective, collectively, all the actions of all buyers and sellers in a particular market may be interpreted as natural phenomenon which follows the same universal principles as other natural phenomenon exhibiting cyclical growth and decline behavior. As applied to the financial markets, Fibonacci ratio based formula may therefore be used to quantify and predict specific short term situations (e.g. a year or less) based on identifiable repeating or harmonic patterns within a system showing growth and decline cyclic behavior.

As initially described above, the methodology 100 substantially uses harmonic patterns, which may be identified using Fibonacci based, derived and related formulas. In at least one embodiment of the invention the methodology may be using harmonic patterns as substantially relying upon formulas which incorporate two specific Fibonacci ratios or constants, 1.618 (Phi) and its inverse 0.618. In this manner, 1.618 and 0.618 may be considered in at least one embodiment to be the methodology's primary measurement basis. Additionally, other Fibonacci numbers, which may also be utilized in formulae for harmonic patterns to compliment usage of the primary measurement basis, may also be derived directly or indirectly from the primary measurement basis.

It should be noted that the methodology 100 may also used for some numbers, which are not entirely conceived from the Fibonacci sequence or Fibonacci constants. For example, 3.14 (Pi or π) is more related through Ancient Geometry to Phi (1.618) than directly calculated from the Fibonacci numeric sequence. However, Pi may be effective in combination with the primary measurement basis (e.g., the Fibonacci constants or ratios 0.618 and 1.618) for identifying a possible future harmonic price action.

The following ratios or constants (e.g. of the original Fibonacci number sequence) may be used in the methodology 100 to identify and apply harmonic patterns to future or developing price actions.

Primary Ratios:

(Derived directly from the Fibonacci number sequence)
0.618=Primary Ratio
1.618=Primary Ratio

Primary Derived Ratios:
0.786=Square root of the 0.618
0.886=Fourth root of the 0.618
1.13=Fourth root of the 1.618; Inverse of 0.886
1.27=Square root of the 1.618; Inverse of 0.786

Complimentary Derived Ratios:
0.382=(1-0.618); 0.618 squared
0.50=0.707²
0.707=square root of the 0.50
1.41=square root of the 2.0
2.0=(1+1)
2.24=Square root of five V5
2.618=1.618 squared (1.618×1.618)
3.14=Pi (See Illustration)
3.618 (1+2.618)

Retracement/Projection

As stated above, many financial markets substantially follow a wave or cyclic growth-decline pattern characterized by peaks and troughs, wherein a peak market performance (e.g., a high price for the particular market instrument, such a stock, commodity, or the like) is followed by a downswing in the price to a low price or trough. The low price or trough then generally is followed by an upswing in market performance or price to a high point in performance or peak before continuing onto a corresponding downswing.

To help analyze when an upcoming change or potential reversal zone in the market performance is coming, a retracement or projection or both may be employed to determine when the next high or low point (peak or trough) in the market is going to occur to allow operator to participate in the market at an advantage. The retracement or projection could be defined as that result of a formula which takes the difference between market price of the instrument of the chosen market (e.g., stock, commodities, etc) at points of distinction in the history of the market place performance (e.g., a trough and a peak) and multiplies it by a market price differential multiplier. The market price differential multiplier may be a Fibonacci number (e.g., a primary Fibonacci ratio or constant, a primary derived Fibonacci ratio or a complementary derived Fibonacci ratio, or by a Fibonacci number which is chosen from a range of primary Fibonacci ratios, primary derived Fibonacci ratios, or complimentary derived Fibonacci ratios). The retracement is substantially used to confirm a market price that was established at a particular time, such as a historical point (e.g., a peak or trough). The retracement can be used in this fashion to help indicate if a proper harmonic pattern has been employed in the analysis. The projection is primarily used to determine a substantially specific financial market performance (e.g., a market price) whose future occurrence may signal a possible a new peak or trough and the beginning of a potential reversal zone. The potential zone reversal may be seen as a term of market performance wherein the market activities have substantially significant changes in direction from the previous financial market activities. An example of a change in direction may be from where the prices of the financial market have steadily grown in value (upswing or bull market) to having started to fall in value (downswing or a bear market). Each of the harmonic patterns of the methodology may use multiple retracements, projections or both to repeatedly confirm the existence of historical points of the financial market and to repeatedly predict at least one future point which may signal the beginning of a potential zone reversal.

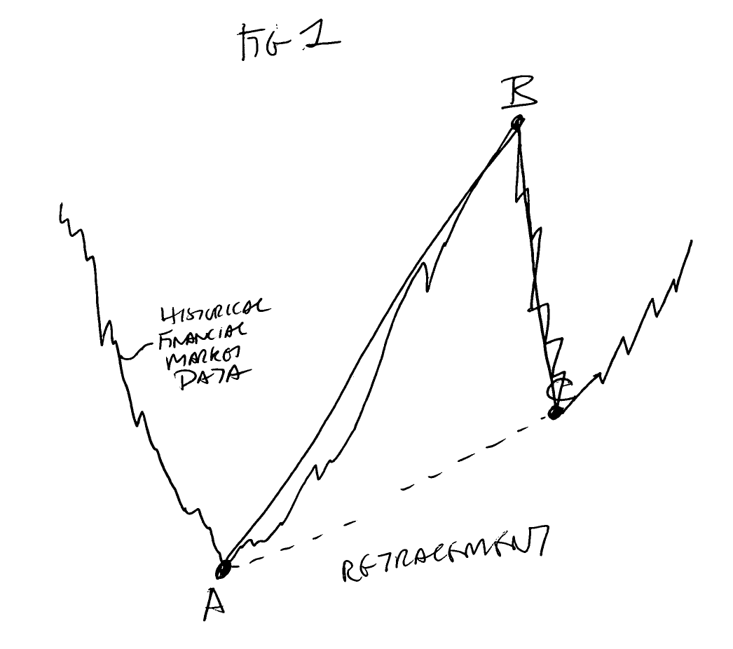

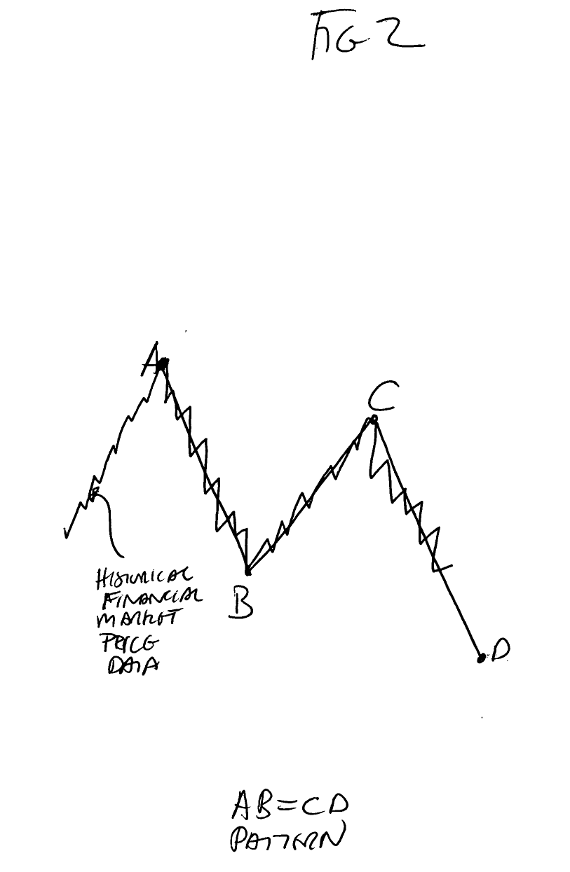

As shown in FIG. 1, an example of 0.618 retracement is shown as applied to a historical record of bearish financial market trend (e.g., a market downswing). Here the operator could take the price of an instrumentality (e.g., a stock price of a particular corporation) at a preceding point of distinction A (e.g. a trough or valley in the present example) and compare it to the price of the instrumentality at a subsequent point of distinction B (e.g., a following peak in the present example). The difference of the two prices is then multiplied by a market price differential multiplier (in this example, 0.618, a primary Fibonacci ratio). The resulting retracement amount or value should be the price of an instrumentality at the next point of distinction C (in the present example, a trough) following point of distinction B. When the formula is applied to points of distinction, A, B, and C as historical points, the result is a called a retracement. It is used to substantially identify that the chosen portion of the financial market being analyzed may have a harmonic pattern occurring within that portion. When the formula is applied to only two historical points of distinction (A and B), then the result is a projection to predict the market price at whose occurrence signals point of distinction C and the beginning of a potential zone reversal. As stated above, when an operator knows with some degree of certainty about when a price zone reversal is about to take place, he/she could limit the risks in participating in the financial market.

As stated above, the market price differential multiplier could employ in addition to the primary Fibonacci ratios or constants, primary and complementary derivatives of the primary Fibonacci ratios or constants. Primary derived market price differential multipliers could include the numbers 0.886, 0.786, 1.13 and 1.27. Complementary derived market price differential multipliers could be numbers indirectly derived from the Fibonacci sequence and primary measurement basis, including numbers 0.382, 0.50 and 0.707. Extreme complementary derived market price differential multipliers for those harmonic patterns having or encompassing extreme price action in the market may include the number 2.618, 314 and 3.618. In use of all such market price differential multipliers, the numbers may be used with a degree of variation (+ ∘ −) of up to 3% of the original value of the selected number and still be considered within the purview of the invention.

The methodology uses harmonic patterns comprising of multiple retracements and projections (primary, primary derived, complimentary derived and extreme complimentary derived market price differential multiplier) to help identify upcoming potential reversal zone for that market. The multiple retracements allows the operator to confirm historical points of distinction as possibly belonging to a harmonic pattern, while multiple projections substantially predict an upcoming point of distinction and correspondingly, the beginning of a potential reversal zone. These multiple means of confirmation that may be seen substantially reduce the risk of a misapplication of Fibonacci analysis to the market and properly identify the existence of an upcoming predictable Fibonacci event (e.g. point reversal zone).

The methodology uses at least 6 basic harmonic patterns, the AB=CD pattern, a four point pattern, and several 5 point patterns such as the Bat pattern, the Crab pattern, the Gartley pattern, the Ideal Butterfly pattern, and 5-0 harmonic pattern.

Harmonic Patterns

The AB=CD Harmonic Pattern

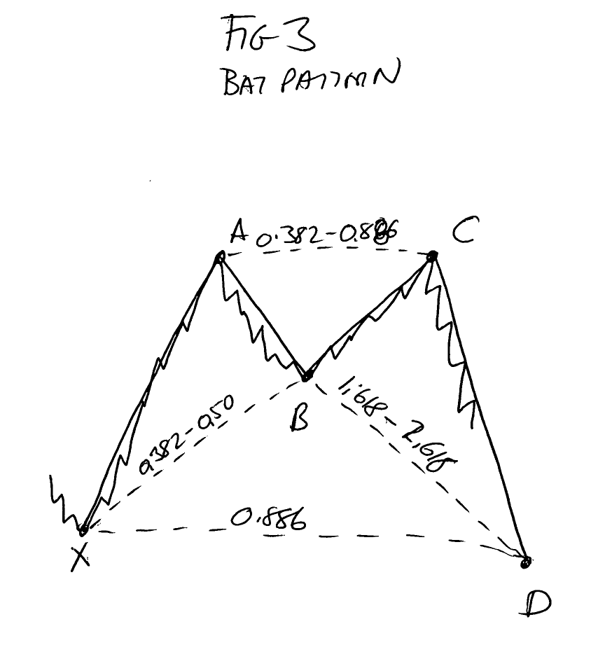

As shown substantially in FIG. 2, the AB=CD pattern is a four point harmonic pattern which may be considered the developmental basis for other harmonic patterns. The AB=CD is four point pattern in that it is analyzing three historical points (A, B, and C) of distinctions (e.g., trough A, peak B, tough C or peak A, trough B and peak C) of a portion of an financial market's activity to substantially predict the market price of the future D point of distinction so as to be able to substantially predict when the future D point of distinction will occur along with the beginning of a potential reversal zone.

In bullish potential reversal zone analysis, using the AB=CD harmonic pattern, the A point of distinction is a first peak, the B point of distinction is the following first trough, the C point of distinction is the following second peak and the D point of distinction is a following and future second trough whose market price is to be determined by the AB=CD harmonic pattern (as the potential start of the bullish or upswing potential reversal zone). In a bearish potential zone analysis, the A point of distinction is a first trough, the B point of distinction is following first peak, the C point of distinction is the following second peak, and the D point of distinction is a following future second peak whose market price is to be substantially determined by the AB=CD harmonic pattern. The future occurrence of D's market price in the financial market during the present market trend (e.g., the upswing) could signal the potential start of the bearish (e.g., downswing) potential reversal zone.

The AB=CD pattern relies upon one retracement and one projection, namely the A-B retracement (between A and B to confirm C's historical price) and a B-C projection to predict the future market price at which future point of distinction D (and hence the beginning of the potential reversal zone. For A-B retracement, the operator generally takes the difference of the market prices for points of distinction A and B and multiplies it by the appropriate market price differential multiplier (up to 3%=/−variance). If the result or retracement is the value of the point of distinction C (or within 3%+/−variance thereof) this could substantially establish that the AB=CD harmonic pattern is being appropriately applied to this portion of the financial market activity.

For B-C projection, the operator generally takes the difference of the market prices for points of distinction B and C and multiplies it by the appropriate market price differential multiplier (up to 3%=/−variance). The result or retracement should then substantially predict the value of point of distinction C (or within 3%+/−variance thereof) at which the point of distinction D should occur along with the beginning of the potential zone reversal.

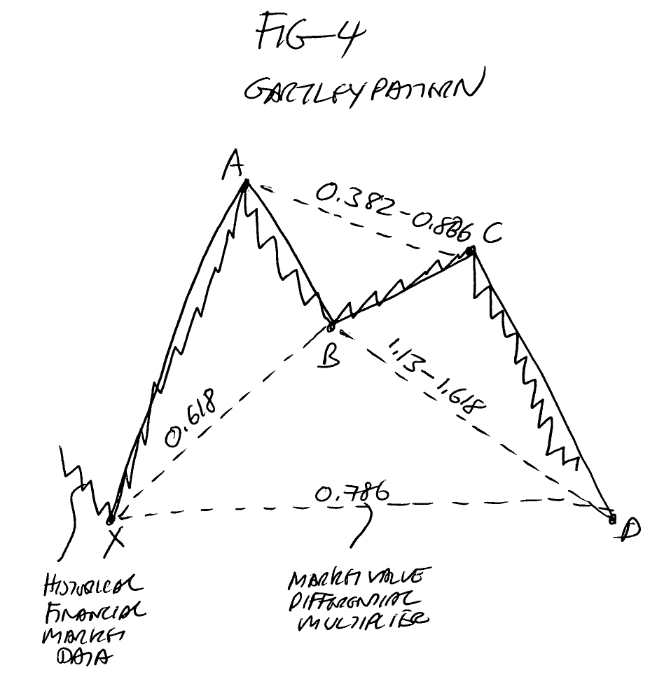

As substantially shown in FIG. 3A, the standard AB-CB harmonic patterns should have market price deferential multiplier selected from a range between 0.382 through 0.886. The B-C projection should use a market price deferential multiplier selected from a range 1.13 through 2.618 as the market price differential multipliers to give a range wherein D's price should fall within. As for all harmonic patterns for the invention, the selected market price differential multiplier could be a value that is up to 3%−/+of the selected Fibonacci numbers.

It should be explained that the selected range for Fibonacci numbers, also includes those Fibonacci numbers, which fall between the two cited numbers. Hence for an A-B retracement having a market price differential multiplier with a cited Fibonacci range (e.g., for point C price confirmation) from 0382 through 0.866, the numbers 0.382, 0.50, 0.618, 0.707, 0.786, or 0.886 may be used as that market price differential multiplier (with an up to +/−3% variance). Similarly, for the B-C projection market price differential multiplier having a cited Fibonacci range cited of 1.13 through 2.618, the numbers 1.13, 1.27, 1.41, 1.618, 2.0, 2.24, or 2.618 may be used as the range for a market price differential multiplier (with an up to +/−3% variance).

A perfect (hence highly reliable) AB=CD harmonic pattern would have an A-B retracement with a market price differential multiplier of 0.618 and a B-C projection with a market price differential multiplier of 1.618. The time duration for which the market activities are measured for the A-B retracement and the C-D projection should be very similar if not the same.

The Bat Harmonic Pattern

As substantially shown in FIG. 3, the Bat harmonic pattern is a five point pattern analyzing several peaks and troughs (five total) of a portion of a financial market's activity to predict a potential reversal zone. In bullish potential reversal zone analysis, the X point of distinction is the first trough, the A point of distinction is the following first peak, the B point of distinction is the following second trough, the C point of distinction is the following second peak and the D point of distinction is a following future third trough whose occurrence (and hence the potential start of the bullish (e.g., upswing) potential reversal zone) should be predicted by a price value determined by the Bat harmonic pattern. In a bearish potential zone analysis, the X point of distinction is the first peak, the A point of distinction is the following first trough, the B point of distinction is the following second peak, the C point of distinction is the following second trough, and the D point of distinction is the following future third peak. When the market price of D point of distinction (predicted by the Bat harmonic pattern) occurs during the current market trend this could signal the start of the bullish (e.g., upswing) potential reversal zone.

The Bat pattern generally has two retracements and two projections. The two retracements could include an X-A retracement (for the confirmation of B's historical market price) and an A-B retracement (for confirmation of C's historical market price). The X-A retracement uses a market price differential multiplier of less than 0.618, preferably 0.382 or 0.50. The A-B retracement uses a market price differential multiplier of a range from 0.382 through 0.886.

The two projections of D are the B-C projection and the X-A projection. The B-C projection uses the market price differential multiplier range of 1.618 through 2.618. In the X-B projection the market price difference is again calculated from the points of distinction X and A, and is multiplied by the market price differential multiplier 0.886.

Within the above the Bat harmonic pattern ranges and applications set forth above, there could be a perfect Bat harmonic pattern which could indicate a very highly predicable potential reversal zone. A perfect Bat harmonic pattern (as could substantially all the harmonic patterns being identified as perfect herein) could generally use a decreased range of market price differential multipliers as set forth above for the Bat harmonic pattern's two retracements and two projections. For the perfect Bat Harmonic pattern, the X-A retracement would use a market price differential multiplier 0.50 while the A-B retracement would use the market price differential multiplier range of 0.50 through 0.618. Correspondingly, the B-C projection would use the market price differential multiplier of 2.0 while the X-A projection would use the market price differential multiplier of 0.886 as before. It should be noted that for all the harmonic patterns denoted as being perfect, their respective market price differential multiplier could include those values having up to 3%−/+variance of the cited Fibonacci numbers.

The Gartley Harmonic Pattern

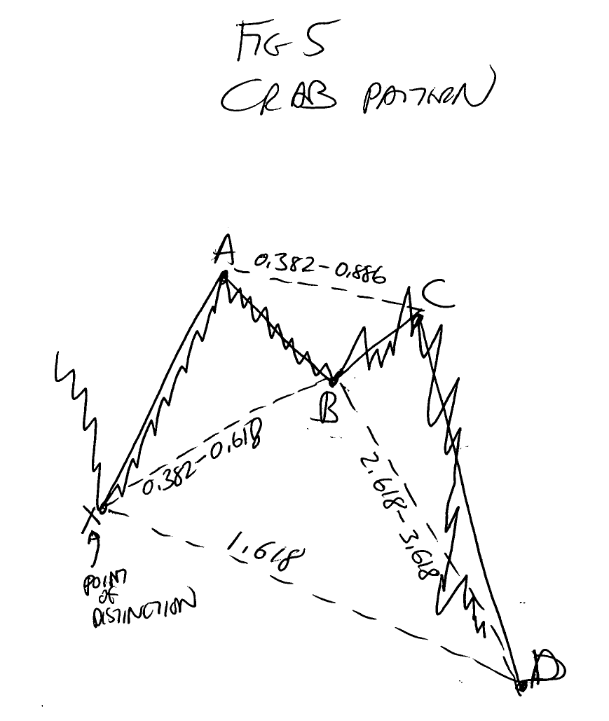

As substantially show in FIG. 4, the Gartley harmonic pattern is a five point pattern analyzing several peaks and troughs (five total) of a portion of a financial market's activity to predict a potential reversal zone. In bullish potential reversal zone analysis, the X point of distinction is the first trough, the A point of distinction is a following first peak, the B point of distinction is the following second trough, the C point of distinction is the following second peak and the D point of distinction is a following future third trough whose market price should be predicted by the Gartley harmonic pattern as occurring during the current market trend to indicate the potential start of the bullish (e.g., upswing) potential reversal zone. In a bearish potential zone analysis, the X point of distinction is first peak, the A point of distinction is a following first trough, the B point of distinction is following second peak, the C point of distinction is the following second trough, and the D point of distinction is a following future third peak whose market price (and hence occurrence) should be predicted by the Gartley harmonic pattern as occurring during the current market trend as the potential start of the bullish (e.g., upswing) potential reversal zone.

The Gartley pattern also generally has two retracements and two projections. The two retracements again could include an X-A retracement (for the confirmation of B's historical market price) and an A-B retracement (for confirmation of C's historical market price). The X-A retracement uses a market price differential multiplier of 0.618. The A-B retracement uses a market price differential multiplier of range from 0.382 through 0.886.

The two projections are the B-C projection for D and the X-A projection for D. The B-C projection is the market price differential multiplier range from 1.13 through 1.618. In the X-A projections, the historical market price difference is again calculated from the historical market values of points of distinction X and A, and is multiplied by the market price differential multiplier of 0.786.

Within the above Gartley harmonic pattern ranges and applications set forth above, there could be a perfect Gartley harmonic pattern which could indicate a very highly predicable potential reversal zone. A perfect Gartley harmonic pattern could generally use a decreased range of market price differential multipliers as set forth above for the Bat harmonic pattern's two retracements and two projections. For the perfect Gartley harmonic pattern, both the X-A retracement and the A-B retracement would use the market price differential multiplier range of 0.618. Correspondingly, the B-C projection would use the market price differential multiplier of 1.618 while the X-A projection would use the market price differential multiplier of 0.786 as before.

The Crab Harmonic Pattern

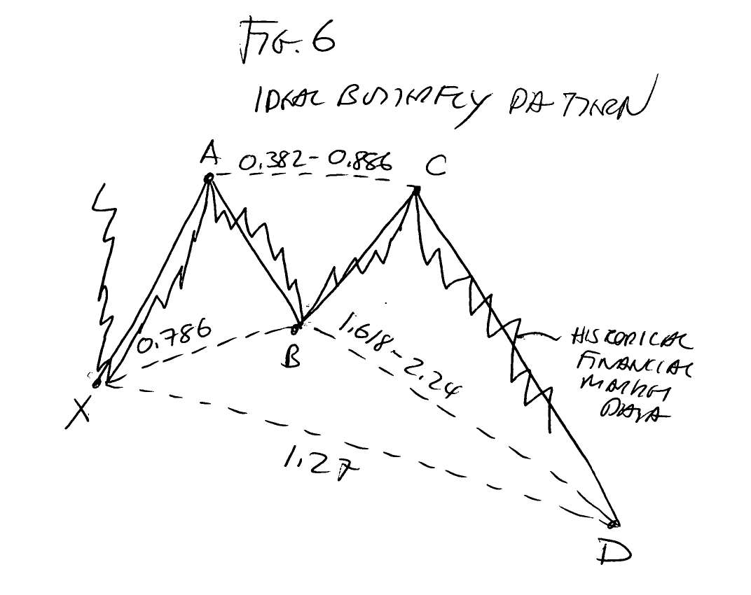

As substantially show in FIG. 5, the Crab harmonic pattern is a five point pattern analyzing several peaks and troughs (five total) of a portion of a financial market's activity to predict a potential reversal zone. In bullish potential reversal zone analysis, the X point of distinction is the first trough, the A point of distinction is a following first peak, the B point of distinction is the following second following trough, the C point of distinction is the following second peak and the D point of distinction is a following future third trough whose market price should be predicted by the Crab pattern as occurring during the current market trend to potentially signal the start of a bullish (e.g., upswing) potential reversal zone. In a bearish potential zone analysis, the X point of distinction is the first peak, A point is the following first trough, the B point of distinction is the following second peak, the C point of distinction is the following second trough, and the D point of distinction is a following future third peak whose market price should be predicted by the Bat pattern as occurring during the current market trend to potentially signal the potential start of the bullish (e.g., upswing) potential reversal zone. The Crab Harmonic pattern can also be seen with an extended C-D leg on the cost chart in comparison to the rest of the pattern as applied to that chart.

The Crab pattern generally has two retracements and two projections. The two retracements could include an X-A retracement (for the confirmation of B's price) and an A-B retracement (for confirmation of C's price). The X-A retracement for B uses a market price differential multiplier range of 0.382 through 0.618. The A-B retracement for C uses a market price differential multiplier range of 0.382 through 0.886.

The two projections of point of distinction D are the B-C projection and the X-A projection. The B-C projection uses the market price differential multiplier range of 2.618 through 3.618. The X-A projection uses the market price differential multiplier 0.886.

A variation of the above Crab harmonic pattern is the Deep Crab harmonic where the above retracements and projections are the same except for the X-A retracement which replaces the market price differential multiplier range of 0.382 through 0.618 with market price differential multiplier of 0.886

Within the above the Crab harmonic pattern ranges and applications set forth above, there could be a perfect Crab harmonic pattern which could indicate a very highly predicable potential reversal zone. A perfect Crab harmonic pattern could generally use a decreased range of market price differential multipliers as set forth above for the Crab harmonic pattern's two retracements and two projections. For the perfect Crab Harmonic pattern, the X-A retracement would use a market price differential multiplier 0.618 while the A-B retracement would use the market price differential multiplier range of 0.50 through 0.618. Correspondingly, the B-C projection for D would use the market price differential multiplier of 3.14 while the X-A projection for D would use the market price differential multiplier of 1.618 as before.

The Ideal Butterfly Pattern

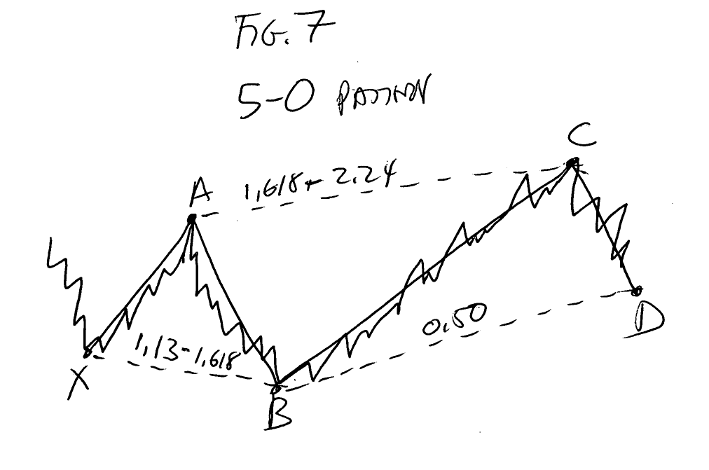

As substantially show in FIG. 6, the Ideal Butterfly harmonic pattern is a five point pattern analyzing several peaks and troughs (five total) of a portion of a financial market's activity to predict a potential reversal zone. In bullish potential reversal zone analysis, the X point of distinction is the first trough, the A point of distinction is a following first peak, the B point of distinction is the following second trough, the C point of distinction is the following second peak and the D point of distinction is a following future third trough whose market price (and hence occurrence) should be predicted by the Ideal Butterfly pattern to occur during the current market trend to indicate the potential start of the bullish (e.g., upswing) potential reversal zone. In a bearish potential zone analysis, the X point of distinction is first peak, the A point of distinction is a following first trough, the B point of distinction is following second peak, the C point of distinction is the following second trough, and the D point of distinction is a following future third peak whose market price should be predicted by the Ideal butterfly pattern as occurring during the current market trend as indicating the potential start of the bullish (e.g., upswing) potential reversal zone.

The Ideal Butterfly harmonic pattern has two retracements and two projections. The two retracements could include an X-A retracement (for the confirmation of B's price) and an A-B retracement (for confirmation of C's price). The X-A retracement uses a market price differential multiplier 0.786. The A-B retracement uses a market price differential multiplier of range from 0.382 through 0.886.

The two projections of D are the B-C projection and the X-A projection. The B-C projection uses the market price differential multiplier range of 1.618 through 2.24. In the X-A projection, the market price difference is again calculated from the X and A, and is multiplied by the market price differential multiplier 1.27.

Within the above the Ideal Butterfly harmonic pattern ranges and applications set forth above, there could be a perfect Ideal Butterfly harmonic pattern which could indicate a very highly predicable potential reversal zone. A perfect Ideal Butterfly harmonic pattern could generally use a decreased range for one or more of market price differential multipliers as set forth above for the Ideal Butterfly harmonic pattern's two retracements and two projections. For the perfect Ideal Butterfly Harmonic pattern, the A-B retracement for C point of distinction would use a market price differential multiplier range of 0.50 while the A-B retracement would use the market price differential multiplier range of 0.50 through 0.618.

The 5-0 Harmonic Pattern

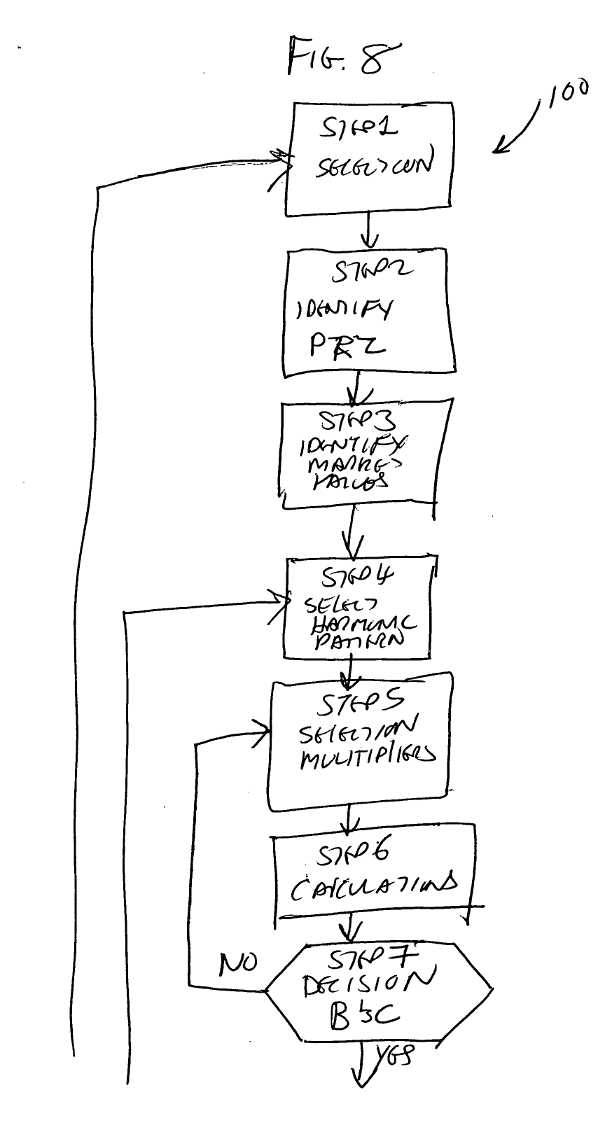

As substantially show in FIG. 7, the 5-0 harmonic pattern is a five point pattern analyzing several peaks and troughs (five total) of a portion of a financial market's activity to predict a potential reversal zone. In bullish potential reversal zone analysis, the X point of distinction is the first trough, the A point of distinction is a following first peak, the B point of distinction is the following second following trough, the C point of distinction is the following second peak and the D point of distinction is a following future third trough whose market price should be predicted by the 5-0 pattern as occurring during the current market trend to potentially signal the start of a bullish (e.g., upswing) potential reversal zone. In a bearish potential zone analysis, the X point of distinction is the first peak, A point is the following first trough, the B point of distinction is the following second peak, the C point of distinction is the following second trough, and the D point of distinction is a following future third peak whose market price should be predicted by the 5-0 pattern as occurring during the current market trend to potentially signal the potential start of the bullish (e.g., upswing) potential reversal zone.

The 5-0 pattern generally has two retracements and only one, not two, projections. The two retracements could include an X-A retracement (for the confirmation of B's price) and an A-B retracement (for confirmation of C's price). The X-A retracement for B uses a market price differential multiplier range of 1.13 through 1.618. The A-B retracement uses a market price differential multiplier range of 1.618 through 2.24.

The one projections of D are the B-C projection. There is no X-A projection. The B-C projection uses the market price differential multiplier range of 5.0.

Methodology

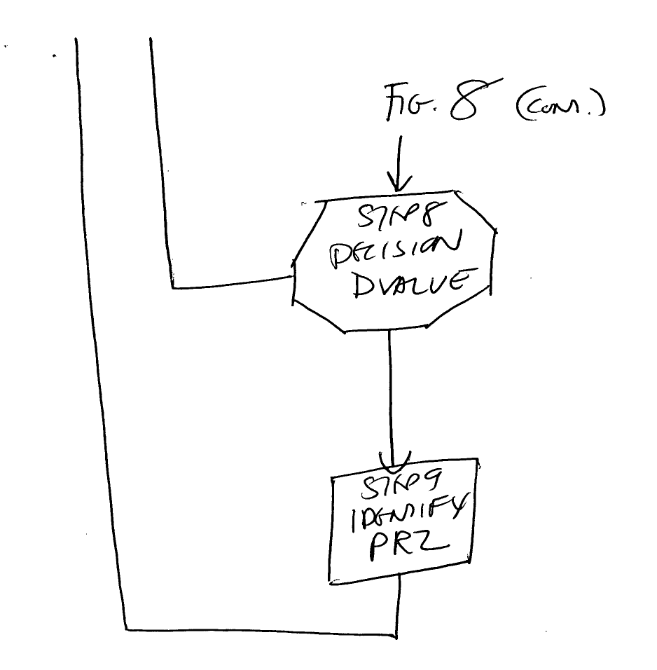

As substantially shown in FIG. 8, the first step of the methodology, 100, could be step 1, the selection of the financial market which to apply the harmonic pattern. Here, the operator could chose in which financial market he or she would in be interested in analyzing and possibly participating. The operator could then obtain the recent historical results (e.g., price cost chart, if the pattern is being applying manually) of a portion of the selected financial market. The selected financial market could be the relatively current performance of a particular company's stock, for instance. After step 1 is substantially completed, the methodology could generally proceed to step 2, identifying current market trends.

In step 2, identifying the type of the potential reversal zone, the operator could identify the current market's current trend. This could include identifying the current trend as being an upswing or downswing and concurrently identifying the next potential reversal zone and being the opposite of the current trend. After step 2 has been substantially completed, the methodology could generally continue onto step 3, identifying the market price values for points of distinction A, B, and C.

In step 3, identifying the market price values for historical points of distinction A, B, and C, the operator could identify the point of distinction C as being the peak or valley origination of the current market tend and the market price of the point of distinction C as taken from the data. The operator could then identify the point of distinction B as being that point of distinction, which directly precedes point of distinction C and as also being the origination of the market trend leading up to point of distinction C. The market trend (origination of point of distinction B) would generally be seen as being opposite in activity (e.g., a downswing trend) to the market trend (origination of the point of distinction C) (e.g., an upswing trend). Based on the location of the point of destination B in relation to the data (e.g. cost price chart), the operator could determine the market value point of distinction B.

The operator could then proceed to identify the point of distinction A as being the historical point of distinction directly preceding the point of distinction B and as being the origination of the market trend leading up to point of distinction B. The market trend (origination of point of distinction A) would generally be seen as being opposite in activity (e.g., an upswing trend) to the market trend (origination of point of distinction B) (e.g., a downswing trend). Based on the location of point of destination A in relation to the data (e.g. cost price chart), the operator could determine the market value point of distinction A.

The operator could then proceed to identify point of distinction X as being the point of distinction directly preceding point of distinction A and as being the origination of the market trend leading up to point of distinction A. The market trend (origination of point of distinction X) would generally be seen as being opposite in activity (e.g., a downswing trend) to the market trend (origination of point of distinction B) (e.g., an upswing trend). Based on the location of the point of destination X in relation to the data (e.g. cost price chart), the operator could determine the market value point of distinction X.

After substantially completing step 3, the methodology could go onto step 4, selection of the harmonic pattern.

In step 4, the selection of a harmonic pattern, the operator would first select a harmonic pattern from a set of harmonic patterns comprising consisting of the Bat, the perfect Bat, Gartley, the perfect Gartley, the Ideal Butterfly, the perfect Ideal butterfly, the Crab, the perfect Crab, the deep Crab and 5-0 harmonic patterns. (The 5-0 pattern would be used without reference to the X-A projection of D because it is lacking this projection). After completing step 4, the process could generally continue onto Step 5, selection of the values for market price differential multipliers.

At step 5, selection of the values for market price differential multipliers, the operator could select from the chosen harmonic pattern, the prescribed values for market price differential multipliers (e.g., the above-described Fibonacci ratios, primary derived ratios, complimentary derived ratios and appropriate ranges of same [with up to +/−3% variance]) for the X-A retracement, X-A projection, A-B retracement, and B-C projection. After completing step 5, the methodology 100 could proceed generally onto step 6, calculating the retracements and projections

In step 6, calculating the retracements and projections, the operator could first take the difference between the market values of X and A points of distinction and multiply it by the market price differential multiplier selected for the X-A retracement to confirm historical market value of B. The operator could then take the difference between the market values of points of distinction X and A and multiply it by the selected market price differential multiplier for the X-A projection to predict the future market value of D. The operator could then take the difference between the historical market values of A and B points of distinction and multiply it by the market price differential multiplier selected for the A-B retracement to confirm the historical market value of point of distinction C. The operator could then take the difference between the historical market values of points of distinction B and C and multiply it by the market price differential multiplier selected for the B-C projection to predict the future market value of D. At the general conclusion of step 6, the methodology could generally proceed to step 7, decision on the comparison of the calculated and historical values of the points of distinction B and C.

In step 7, decision on the comparison of the calculated and historical values of points of distinction B and C, the operator compares the differences between the calculated and historical values of the points of distinction B and C. If the calculated market values varies by 3% or less the operator may decide yes to continue onto step 8, decision on calculated market values for D. If the calculated market values varies by more than 3%, the operator may decide no and go back to step 5, selection of the values for market price differential multipliers.

At step 8, the decision on the calculated values of D, the operator compares the calculated values of point of distinction D as proved by the above-mentioned projections. If the calculated market values of the point of distinction varies by 3% or less, the operator may decide yes to continue onto step 9, identify occurrence potential reversal zone. If the market values of D varies by more than 3%, the operator may decide no and go back to step 4, selection of the harmonic pattern.

At step 9, identify a potential reversal zone, the operator uses the calculated market value(s) of point of distinction D to determine if and when the operator should participate in the chosen financial market. When the market approximately reaches the calculated market values or the range of the calculated market values of the point of distinction D, the operator may engage the market (sell at a high price or buy at a low price) to make a profit on substantially short term trading. After making the trade, the methodology could proceed back to step 1, the selection of the financial market which to apply the harmonic pattern.

### CONCLUSION

As can be seen by the above description, the invention provides a Fibonacci-based methodology which may provide an ability to lower an investor's risk while participating in short term finial market trading by potentially identifying and applying harmonic patterns to historical financial market data to substantially identify when a potential zone reversal for a current market place trend may occur. Although the description above contains many specifications, these should not be construed as limiting the scope of the invention but as merely providing illustrations of some of the presently preferred embodiments of this invention. Thus, the scope of the invention should be determined by the appended claims and their legal equivalents rather than by the examples given.

I claim as my invention,

1. A methodology of utilizing Fibonacci numbers to analyze financial market patterns:
(A) Selecting the financial market and the data to be analyzed;
(B) Identifying in data the actual market values of four historical points of distinction X, A, B and C;
(C) Selecting at least one harmonic pattern from a set of harmonic patterns consisting of the Bat, the perfect Bat, Gartley, the perfect Gartley, the Ideal Butterfly, the perfect Ideal butterfly, the Crab, the perfect Crab, the deep Crab harmonic patterns.
(D) Selecting the Fibonacci values for the market price differential multipliers for X-A retracement, X-A projection, A-B retracement, and B-C projection based on the selected harmonic pattern;
(E) Calculating market place values of points of distinction B and C using X-A retracement and using A-B retracement;
(F) Comparing the calculated market values of points of distinction B and C to the actual market values of points of distinction B and C derived for the data;
(G) Calculating the predicted market values of point of distinction D using the X-A projection and the B-C projection; and
(H) Deciding to use predicted market values of point of distinction D to determine the occurrence of a potential reversal zone in the current market trend of the financial market being analyzed.

2. A methodology of claim 1 further comprising the step of participating in the market on the basis of the values of D. the basis of the values of D.

3. A methodology of claim 1 wherein using the X-A retracement is taking the difference between the historical market values of points of distinction X and A, and multiplying it by a selected market price differential multiplier for the X-A retracement to confirm the market value of point of distinction B.

4. A methodology of claim 1 wherein using the A-B retracement is taking the difference between the historical market value of the points of distinction A and B and multiplying it by a selected market price differential multiplier for the A-B retracement to confirm the market value of point of distinction C.

5. A methodology of claim 1 wherein using the X-A projection is taking the difference between the historical market values X and A sequential points and multiply it by the selected market price differential multiplier for the X-A projection to confirm the market value of C.

6. A methodology of claim 1 wherein using the B-C projection is taking the difference between the historical market values for the points for distinction B and C and multiply it by the selected market price differential multiplier for the B-C projection to predict a market value of D.

7. A methodology of claim 1 wherein the Bat harmonic pattern has Fibonacci values for the market price differential multipliers that are within at least a 3% or less variance of a range of 0.382 through 0.50 for the X-A retracement, 0.886 for the X-A projection, a range of 0.382 through 0.886 for the A-B retracement, and a range of 1.618 through 2.618 for the B-C projection.

8. A methodology of claim 1 wherein the perfect Bat harmonic pattern has Fibonacci values for the market price differential multipliers that are within at least a 3% or less variance of 0.50 for the X-A retracement, 0.886 for the X-A projection, range of 0.05 through 0.618 for the A-B retracement, and 2.0 for the B-C projection.

9. A methodology of claim 1 further wherein the Gartley pattern has Fibonacci values for the market price differential multipliers that are within at least a 3% or less variance of 0.618 for the X-A retracement, 0.786 for the X-A projection, a range of 0.382 through 0.886 for the A-B retracement, and a range of 1.13 through 1.618 for the B-C projection.

10. A methodology of claim 1 further wherein the perfect Gartley pattern has Fibonacci values for the market price differential multipliers that are within at least a 3% or less variance of 0.618 for the X-A retracement, 0.786 for the X-A projection, 0.618 for the A-B retracement, and 1.618 for the B-C projection.

11. A methodology of claim 1 further wherein the crab pattern has Fibonacci values for the market price differential multipliers within at least a 3% or less variance of range of 0.382 through 0.618 for the X-A retracement, 1.618 for the X-A projection, a range of 0.382 through 0.886 for the A-B retracement, and a range of 2.618 through 3.618 for the B-C projection.

12. A methodology of claim 1 further wherein the deep crab harmonic pattern has Fibonacci values for the market price differential multipliers that are within at least a 3% or less variance of 0.886 for the X-A retracement, 1.618 for the X-A projection, a range of 0.382 through 0.886 for the A-B retracement, and a range of 2.618 through 3.618 for the B-C projection.

13. A methodology of claim 1 further wherein the perfect crab pattern has Fibonacci values for the market price differential multipliers within at least a 3% or less variance of 0.618 for the X-A retracement, 1.618 for the X-A projection, a range of 0.50 through 0.618 for the A-B retracement, and 3.14 for the B-C projection.

14. A methodology of claim 1 further wherein the ideal butterfly harmonic pattern has Fibonacci values for the market price differential multipliers that within at least a 3% or less variance of 0.786 for the X-A retracement, 1.27 for the X-A prediction, a range of 0.382 through 0.886 for the A-B retracement, and a range of 1.618 through 2.24 for the B-C projection.

15. A methodology of claim 1 further wherein the perfect ideal butterfly harmonic pattern has values for the market price differential multipliers that within at least a 3% or less variance of 0.786 for the X-A retracement, 1.27 for the X-A prediction, a range of 0.50 through 0.886 for the A-B retracement, and 1.618 for the B-C projection.

16. A methodology of claim 1 further wherein the 50 harmonic pattern has values for the market price differential multipliers that within at least a 3% or less variance of range of 1.13 through 1.618 for the X-A retracement, a range of 1.618 through 2.24 for the A-B retracement, and 5.0 for the B-C projection of D.

17. A methodology of utilizing Fibonacci numbers to analyze financial market patterns:
(A) Selecting the financial market and the data to be analyzed;
(B) Identifying in data the actual market values of four historical points of distinction X, A, B and C;
(C) Selecting at least 5-0 harmonic pattern
(D) Selecting the Fibonacci values for the market price differential multipliers for X-A retracement, A-B retracement, and B-C projection based on the 5-0 harmonic pattern;
(E) Calculating market place values of points of distinction B and C using X-A retracement and using A-B retracement;
(F) Comparing the calculated market values of points of distinction B and C to the actual market values of points of distinction B and C derived for the data;
(G) Calculating the predicted market values of point of distinction D using the B-C projection; and
(H) Deciding to use predicted market values of point of distinction D to determine the occurrence of a potential reversal zone in the current market trend of the financial market being analyzed.

18. A methodology of claim 17 wherein using the X-A retracement is taking the difference between the historical market values of points of distinction X and A, and multiplying it by a selected market price differential multiplier for the X-A retracement to confirm the market value of point of distinction B.

19. A methodology of claim 17 wherein using the B-C retracement is taking the difference between the historical market value of the points of distinction B and C and multiplying it by 5-0 Harmonic pattern's market price differential multiplier for the A-B retracement to confirm the market value of point of distinction C.

20. A methodology of claim 17 wherein the wherein the 50 harmonic pattern has values for the market price differential multipliers that within at least a 3% or less variance of range of 1.13 through 1.618 for the X-A retracement, a range of 1.618 through 2.24 for the A-B retracement, and 5.0 for the B-C projection of D.
